(19) United States
(12) Patent Application Publication
(10) Pub. No.: US 2017/0056762 A1
(43) Pub. Date: Mar. 2, 2017

(54) DEVICES AND METHODS FOR APPLYING EXTERNAL CONTROLERS TO MOBILE ELECTRONIC DEVICES OF ANY SHAPE OR MAKE

(71) Applicant: ERAN GAFNI, Gadot (IL)

(72) Inventor: ERAN GAFNI, Gadot (IL)

(21) Appl. No.: 14/840,350

(22) Filed: Aug. 31, 2015

(51) Int. Cl. A63F 13/24; A63F 13/235

(52) U.S. Cl. CPC A63F 13/24; A63F 13/235

(57) ABSTRACT

The invention discloses devices and methods for attaching game controller elements to a mobile electronic device such as a tablet computer or a smartphone. In some embodiments of the instant invention, controller elements may be brought into contact with a tablet or smartphone, locked in place, and then brought into electrical communication with the tablet or smartphone. Electronic devices may be placed in portrait or landscape orientation, and communication between electronic device and controllers may be wired and/or wireless.

### FIELD AND BACKGROUND OF THE INVENTION

The present invention, in some embodiments thereof, relates to methods and devices for attaching controllers to tablet computers and similar mobile computing devices. The instant invention, in some embodiments, allows for more powerful gaming by placing game controllers on either side of a tablet computer, smartphone, or similar mobile electronic device.

Smartphones and tablet computers have had an enormous impact on society. Apple, Inc. alone ships tens of millions of such devices each month, and today smartphone sales outstrip “dumb” phone sales, even though the former are extremely advanced computing systems and inherently more expensive. Tablets and smartphones invariably have touchscreens which enhance user interface as well as usability of such devices.

One weakness of the current generation of tablet computers, smartphones, and the like is the limitations for user input. Though “multi-touch” systems generally found on Apple and Samsung devices allow for a few fingers to be recognized at one time, the ability to input multiple unique signals at once is ultimately limited when compared to say computers, Microsoft X-Box, or Sony PlayStation which generally use game controllers to allow for numerous preprogrammed buttons for simultaneous or sequential use throughout a game or application. Such limitations to input have generally made tablet computers and smartphones poor contenders in the world of “serious gamers”.

U.S. Pat. No. 9,005,026 to Joynes and Bower teaches an apparatus generally directed to controlling a video game. The apparatus preferably includes a tablet computer, an electronic game communicating with the tablet computer, and an input device for controlling movement of a virtual object provided by the electronic game. Preferably, the input device includes a pair of opposing side structures adjacent opposing sides of plurality of sides of the tablet computer. The input device further preferably includes a plurality of input switches, wherein said input switches are adjacent each of the at least two opposing sides of the plurality of sides of the tablet computer, and a bridge structure disposed between the pair of sides to form a three sided structure. The third structure mitigates inadvertent removal of the tablet computer from the three sided structure when the tablet computer is fully nested within the three sided structure.

U.S. Pat. No. 8,529,357 to Joynes, et al. describes an apparatus generally directed to a combination tablet computer and game controller. The tablet computer provides a plurality of sides, in which each of the sides are disposed between an electronic display screen and a back. The computer game controller provides side structures adjacent the tablet computer on at least two opposing sides. The computer game controller further preferably providing input module apertures and a camera. Preferably, each input module aperture selectively accepts either a game control module or a removable keyboard module. The input module apertures are preferably adjacent each of the at least two opposing sides of the tablet computer, and the camera communicates with each the electronic game controller and the tablet computer. The electronic game controller further provides an integrated transaction card input feature.

U.S. patent application Ser. No. 13/220,872 to Lin teaches a supplementary game controller for tablet computers is revealed. The supplementary game controller for tablet computers includes a universal ball joint disposed between a fixing base and a connection base. The fixing base is fixed on a plane while the connection base is used to hold a tablet computer. Thereby the supplementary game controller is inclined at different angles or rotated in different directions through the universal ball joint while users hold the connection base so as to control characters and movements in games running on the tablet computer.

U.S. Design Patent Number D713467 to Sawhney, et al shows a game controller system in which an open space of known dimensions is allotted for insertion of a predetermined tablet computing device, with controller buttons arranged on either side of the open space.

### SUMMARY OF THE INVENTION

It is therefore a purpose of the present invention, in some embodiments, to describe methods and devices for providing a universal external controller system that may be applied to any mobile computing system (or screen) and used to control any software or application associated with such a computing system.

The invention includes a device for providing game controller functionality to a mobile electronic device, including: a mobile electronic device; a first game controller element adapted to be placed on a right side of the mobile electronic device when a screen associated with the mobile electronic device is facing upwards; a second game controller element adapted to be placed on a left side of the mobile electronic device; a sliding element adapted to bring the first game controller and the second game controller into contact with the mobile electronic device; a locking element adapted to keep the first game controller and the second game controller locked in place and contacted to the mobile electronic device; and, a communication and power element adapted to allow for communication between the mobile electronic device and the first game controller element and the second game controller element.

In one aspect of the device, the mobile electronic device is selected from tablet computer, smartphone, laptop computer, computer screen, personal gaming device, iPod Touch, or handheld computing device.

In another aspect of the device, the mobile electronic device is placed in a landscape or portrait orientation relative to the first game controller element and the second game controller element.

In another aspect of the device, the communication and power element includes wireless or wired means.

In another aspect of the device, the wireless means include Wi-Fi, Bluetooth, IR, or high frequency waves.

In another aspect of the device, the sliding element includes metal rods, springs, elastic elements, or plastically deformable features adapted to allow the first game controller element to move relative to the second game controller element.

In another aspect of the device, the device allows for touchscreen access to the mobile electronic device in addition to use of the first game controller element and the second game controller element.

In another aspect of the device, the mobile electronic device is selected from Apple, Samsung, Microsoft, HP, Dell, HTC, Sony, Google, or Blue.

In another aspect of the device, the first game controller element includes a plurality of programmable buttons and wherein the second game controller element includes a plurality of programmable buttons.

In another aspect of the device, the first game controller element additionally includes a joystick and wherein the second game controller element includes a toggle stick.

The invention includes a method for providing game controller functionality to a mobile electronic device, including the following: providing a mobile electronic device; placing the mobile electronic device on a sliding element, wherein a screen of the mobile electronic device is facing upwards; pushing a first game controller element from a first side and a second game controller element from a second side of the mobile electronic device along the sliding element until the first game controller element and the second game controller element are in physical contact with the mobile electronic device; locking the first game controller element and the second game controller element in place along the sliding element; and, providing electrical communication between the mobile electronic device and the first game controller element and the second game controller element.

In one aspect of the method, the mobile electronic device is realized as an iPad or Samsung tablet computer or an iPhone or Samsung Galaxy smartphone.

In another aspect of the method, the sliding element is adapted to allow the first game controller element to move relative to the second game controller element.

In another aspect of the method, the first game controller element and the second game controller element are adapted to move relative to each other to allow for any type of mobile electronic device to sit between them.

In another aspect of the method, the first game controller element is adapted to include a plurality of programmable buttons for right hand use and the second game controller element is adapted to include a plurality of programmable buttons for left hand use.

The invention also provides for a device for providing a hardware controller over software for a mobile electronic device, including: a mobile electronic device; a first controller element adapted to be placed on either a right side or a left side of the mobile electronic device; a contact element adapted to bring the first controller element into physical contact with the mobile electronic device; a locking element adapted to keep the first controller element contacted to the mobile electronic device; and, a communication means adapted to allow for communication between the mobile electronic device and the first controller element.

In one aspect of the device, the mobile electronic device is realized as a plurality of mobile electronic devices.

In another aspect of the device, the first controller element includes a plurality of programmable buttons as well as a joystick.

In still another aspect of the device, the locking element is reversibly openable.

In yet another aspect of the device, the mobile electronic device includes at least one app adapted to make use of the plurality of programmable buttons and the joystick associated with the first controller element.

The invention also includes a device for providing game controller-functionality to a mobile electronic device, including: a mobile electronic device; a first game controller element adapted to be placed on a first side of the mobile electronic device when a screen associated with the mobile electronic device is facing upwards; a second game controller element adapted to be placed on a second side of the mobile electronic device; a first clamping element adapted to clamp the first game controller in place on the first side of the mobile electronic device; a second clamping element adapted to clamp the second game controller element in place on the second side of the mobile electronic device; and, a communication element adapted to allow for communication between the mobile electronic device and the first game controller element and the second game controller element.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings may have the same number, advanced by the appropriate multiple of 100. Elements of the embodiments may generally be considered to have their known meaning in the art unless stated otherwise.

In the drawings:

FIGS. 1A-1C show prior art inventions related to the instant invention;

FIG. 2 shows a flowchart of a method of the instant invention;

FIG. 3 shows a view of an embodiment of the instant invention;

FIG. 4 shows a tablet computer associated with a device according to this embodiment;

FIG. 5 shows a reverse view of FIG. 4;

FIG. 6 shows detail of a game controller element;

FIG. 7 shows detail of a controller unit and its associated buttons and joy stick;

FIG. 8 shows a schematic view of an embodiment of the invention that lacks a sliding element; and,

FIG. 9 shows a view of a device created according to an Example of the invention.

### DESCRIPTION OF SPECIFIC EMBODIMENTS OF THE INVENTION

The present invention, in some embodiments thereof, relates to methods and devices for providing (game) controller functionality to mobile electronic devices such as tablet computers, smartphones and the like.

The inherent weakness of tablets and smartphones for serious gaming or involved applications has been known for some time. Multi-touch and finger pressure sensitivity have been employed to give greater depth of experience on such platforms. Still, tablets and smartphones do not perform with the same level of reality or intensity as do other platforms such an X-Box or PlayStation.

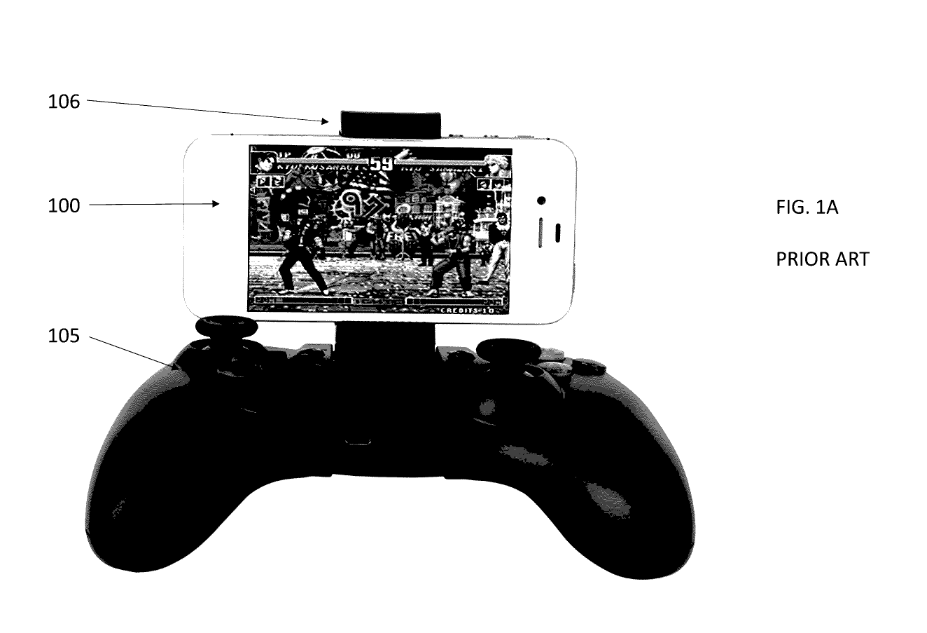

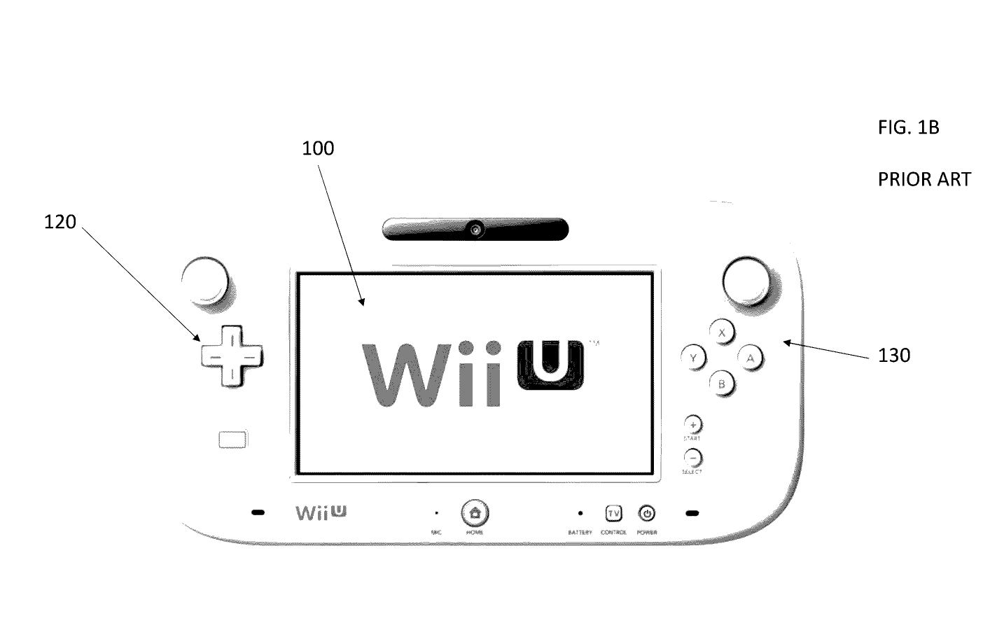

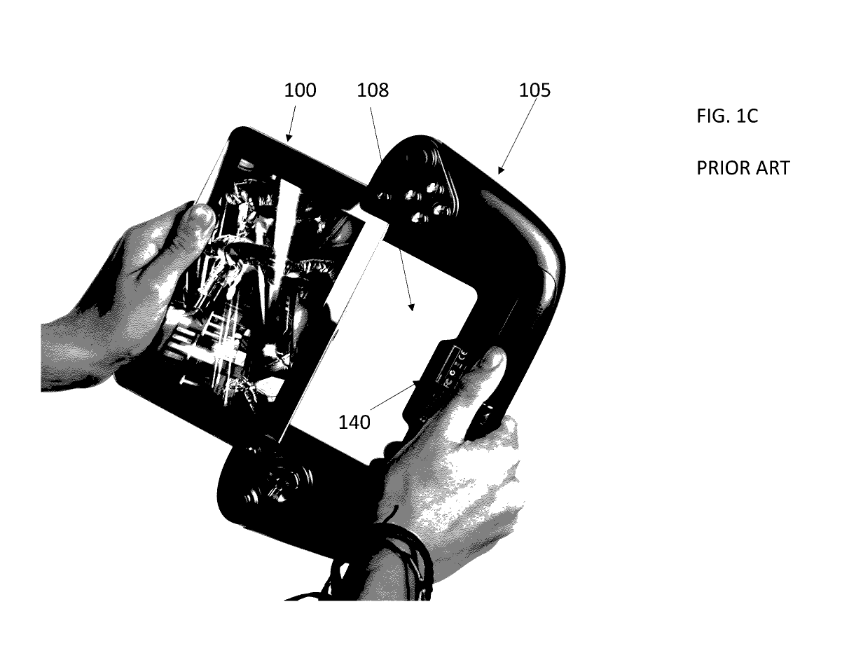

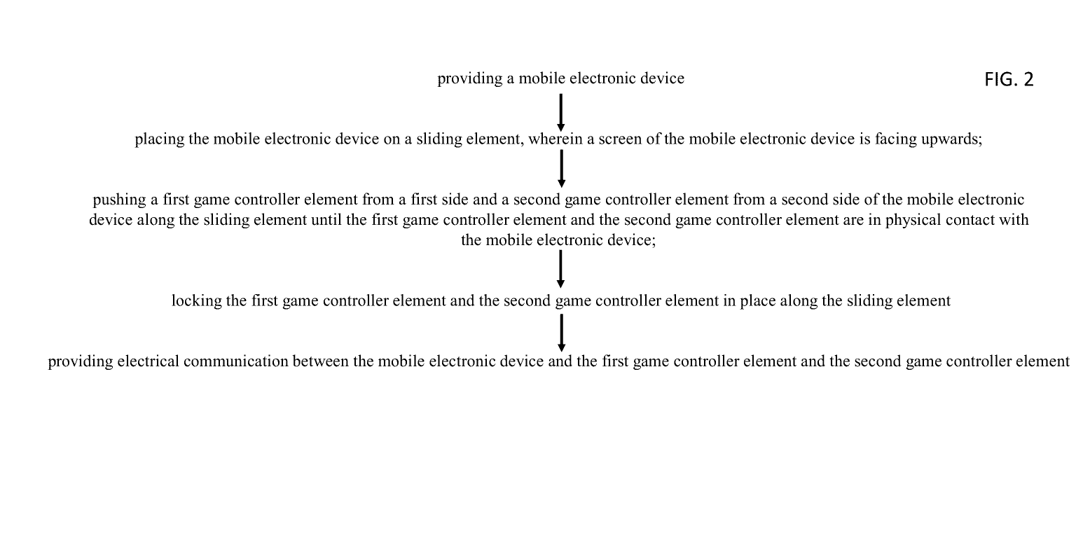

Prior art solutions for this problem generally involve tethering a tablet or smartphone to a fixed arrangement of game controllers. FIG. 1A shows an example of such an approach. A smartphone 100 is anchored to a modified game controller 105. A clamp 106 is adapted to the size of the smartphone 100 and thus limits the size of mobile electronic device that may be used with the game controller 105. Additionally, the smartphone 100 is placed in a landscape orientation and would not fit in a portrait arrangement.

FIG. 1B shows an additional prior art invention. A tablet computer 100 is fixed between left 120 and right 130 game controlling elements. In this arrangement, only a dedicated tablet computer 100 is useful and is permanently associated with its game controlling elements 120 & 130.

Attention is turned to FIG. 1C. FIG. 1C shows a controller device 105 with an open space 108 adapted to receive a tablet computer 100. The open space 108 is fixed and the controller device is directed towards one or a small number of tablet products, as the controller device 105 is not flexible in its construction. A docking element 140 is at the base of the controller device 105 and is adapted for the specific tablet 100 adapted to be placed in and removed from the device 105.

Unlike the prior art inventions, the instant invention, in some embodiments, provides a flexible arrangement of game controller elements. Right and left elements are adapted to move relative one another and thus allow for a good fit with any tablet or smartphone, whether in portrait or landscape arrangement. The instant invention provides for a mechanism to move controller elements and then lock them in place immediately adjacent to a tablet or smartphone and then allow for use and play. All functionality may be transferred to the controllers, or in some embodiments, both controllers and touch screen of a tablet, smartphone, or the like may be used in some combination so as to allow for a more complete experience. All of the prior art inventions are limited in the types of mobile computing devices they can accept—either by size, build or docking element. No such limitations are present in the instant invention.

### First Embodiment

The invention includes a method for providing game controller functionality to a mobile electronic device, including the following: providing a mobile electronic device; placing the mobile electronic device on a sliding element, wherein a screen of the mobile electronic device is facing upwards; pushing a first game controller element from a first side and a second game controller element from a second side of the mobile electronic device along the sliding element until the first game controller element and the second game controller element are in physical contact with the mobile electronic device; locking the first game controller element and the second game controller element in place along the sliding element; and, providing electrical communication between the mobile electronic device and the first game controller element and the second game controller element.

In one aspect of the method, the mobile electronic device is realized as an iPad or Samsung tablet computer or an iPhone or Samsung Galaxy smartphone. In another aspect of the method, the sliding element is adapted to allow the first game controller element to move relative to the second game controller element. In another aspect of the method, the first game controller element and the second game controller element are adapted to move relative to each other to allow for any type of mobile electronic device to sit between them. In another aspect of the method, the first game controller element is adapted to include a plurality of programmable buttons for right hand use and the second game controller element is adapted to include a plurality of programmable buttons for left hand use.

A mobile electronic device for the instant invention may include but is not limited to tablet computers (“tablet” or “tablets”), smartphones, laptop computers, computer screens, iPod Touch devices, and all handheld computing devices. Such a device may be placed with screen facing upwards towards a user on a sliding element. The sliding element allows for movement of the game controller elements so as to bring them into contact proximity to the mobile electronic device. One game controller is brought to a first side, while the other game controller is brought along the sliding element towards another side. Left/right, top/bottom or any combination of sides may be employed. After the game controllers are in place, they are locked so as not to move. The game controllers may be adapted to include ridges or other features to hold the mobile electronic device in place, so that locking of the game controllers leads to fixing of the tablet, smartphone, etc. in place as well. The embodiment includes a source of (optional) electrical energy as well as electrical communication between the game controllers and the mobile electronic device. Such communication may be wireless or wired. In the latter arrangement, a wire may be attached to the mobile electronic device to provide both electrical energy as well as communication between the game controllers and the mobile electronic device.

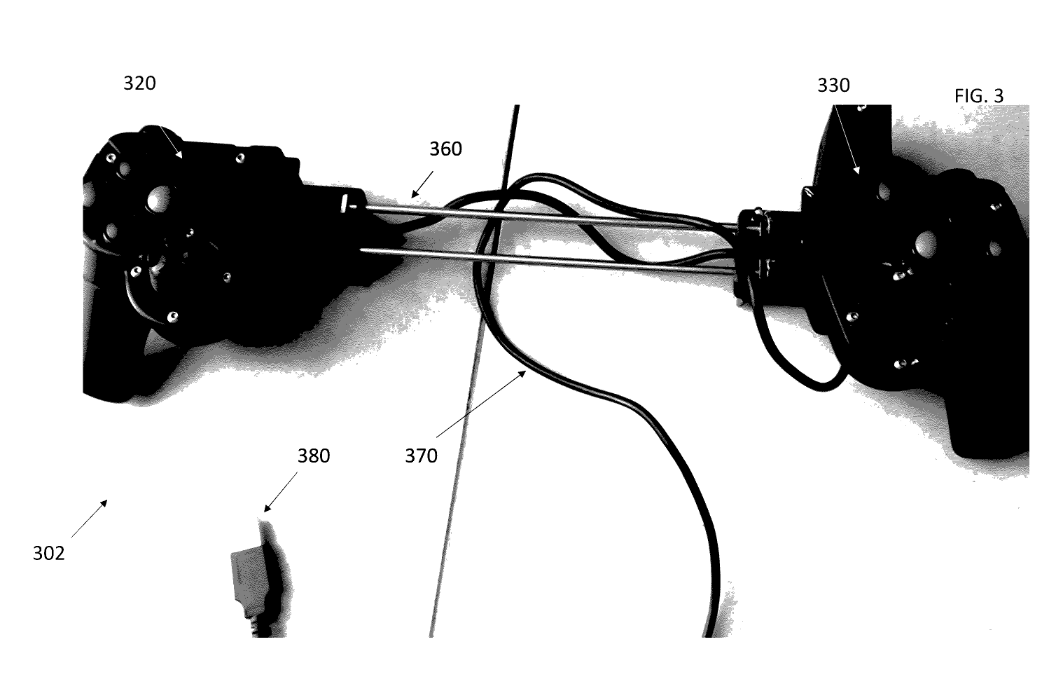

Attention is turned to FIG. 3 which shows a unit 302 built according to the instant embodiment. A left 320 game controller unit and a right 330 game controller unit are attached via a sliding element 360 which allows for each game controller to move in a lateral direction. A communication and electrical power wire 370 is shown; such a wire may have one or a plurality of connection heads 380 to allow for compatibility with a wide range of mobile electronic devices (not shown for purposes of clarity).

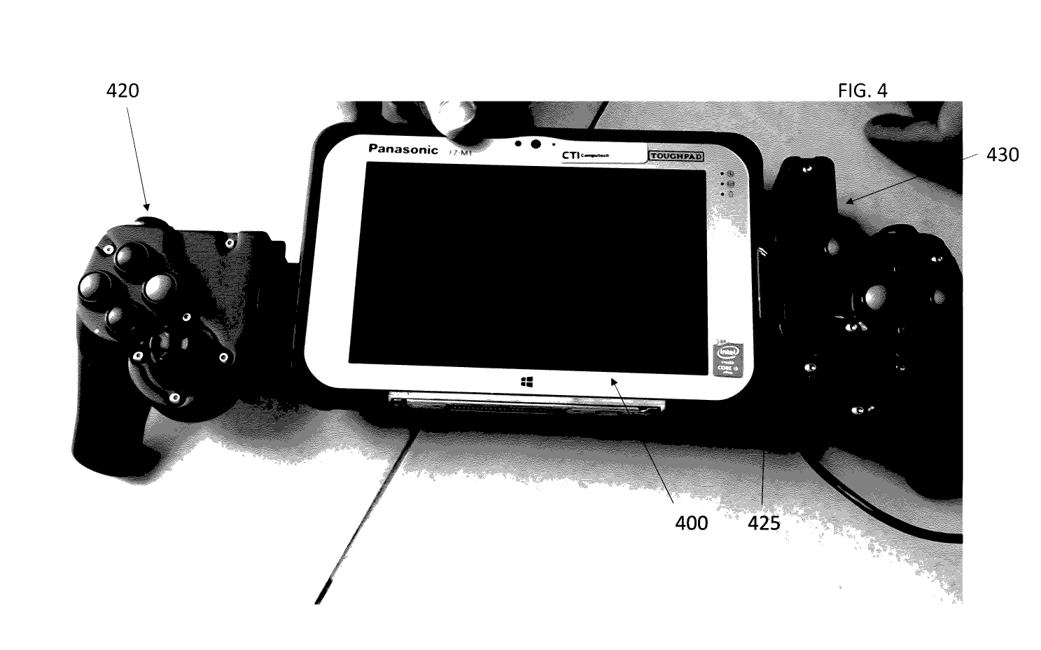

Attention is turned to FIG. 4 which shows a tablet computer 400 placed on the sliding element (not visible). The right game controller element 430 is contacted to the tablet 400 and has a lip 425 to hold the tablet 400 in place. The left game controller element 420 is still some distance from the tablet 400 and must be moved in a rightwards direction so as to contact the tablet 400 and hold the latter in place.

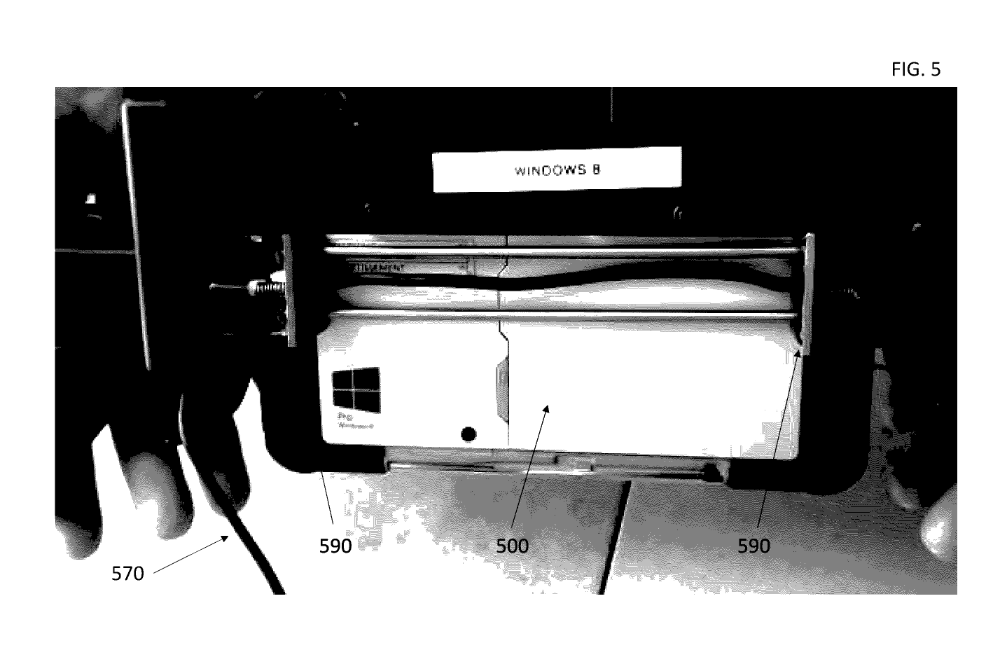

Attention is turned to FIG. 5. FIG. 5 shows the opposite side of the view seen in the previous figure. The tablet computer 500 is locked in place by locking elements 590 adapted to allow movement of the game controller elements and then to lock them in place when the game controller elements are up against the tablet 500. The communication and power wire 570 is seen underneath the tablet 500 where it does not interfere with screen viewing or button access on the two half-game controllers (to the left and right of the tablet 500).

### Second Embodiment

The invention includes a device for providing game controller functionality to a mobile electronic device, including: a mobile electronic device; a first game controller element adapted to be placed on a right side of the mobile electronic device when a screen associated with the mobile electronic device is facing upwards; a second game controller element adapted to be placed on a left side of the mobile electronic device; a sliding element adapted to bring the first game controller and the second game controller into contact with the mobile electronic device; a locking element adapted to keep the first game controller and the second game controller locked in place and contacted to the mobile electronic device; and, a communication and power element adapted to allow for communication between the mobile electronic device and the first game controller element and the second game controller element.

In one aspect of the device, the mobile electronic device is selected from tablet computer, smartphone, laptop computer, computer screen, personal gaming device, iPod Touch, or handheld computing device. In another aspect of the device, the mobile electronic device is placed in a landscape or portrait orientation relative to the first game controller element and the second game controller element. In another aspect of the device, the communication and power element includes wireless or wired means. In another aspect of the device, the wireless means include Wi-Fi, Bluetooth, IR, or high frequency waves. In another aspect of the device, the sliding element includes metal rods, springs, elastic elements, or plastically deformable features adapted to allow the first game controller element to move relative to the second game controller element. In another aspect of the device, the device allows for touchscreen access to the mobile electronic device in addition to use of the first game controller element and the second game controller element. In another aspect of the device, the mobile electronic device is selected from Apple, Samsung, Microsoft, HP, Dell, HTC, Sony, Google, or Blue. In another aspect of the device, the first game controller element includes a plurality of programmable buttons and wherein the second game controller element includes a plurality of programmable buttons. In another aspect of the device, the first game controller element additionally includes a joystick and wherein the second game controller element may include a toggle stick.

One of the advantages of the instant invention is that it may be adapted to accept any smartphone, tablet, handheld computer from any manufacturer. A relevant mobile electronic device may be placed on a sliding element which may be made of plastic rubber, springs, metal or other materials. The sliding element allows movement of one or both of the game controller elements so as to allow their snug contact with the mobile electronic device. Game controller elements may be made of any material and may be of any size—smaller elements may be more appropriate for smartphones than say for tablets. Buttons may range in number and size as well as texture and position as per intended use. Buttons may be augmented with joysticks, toggle switch or other elements. Buttons may be exposed, flush, or sunken or any combination thereof. Buttons may generally be preprogrammed to work with predetermined applications and programs so as to allow a maximum enjoyment in game play or the like.

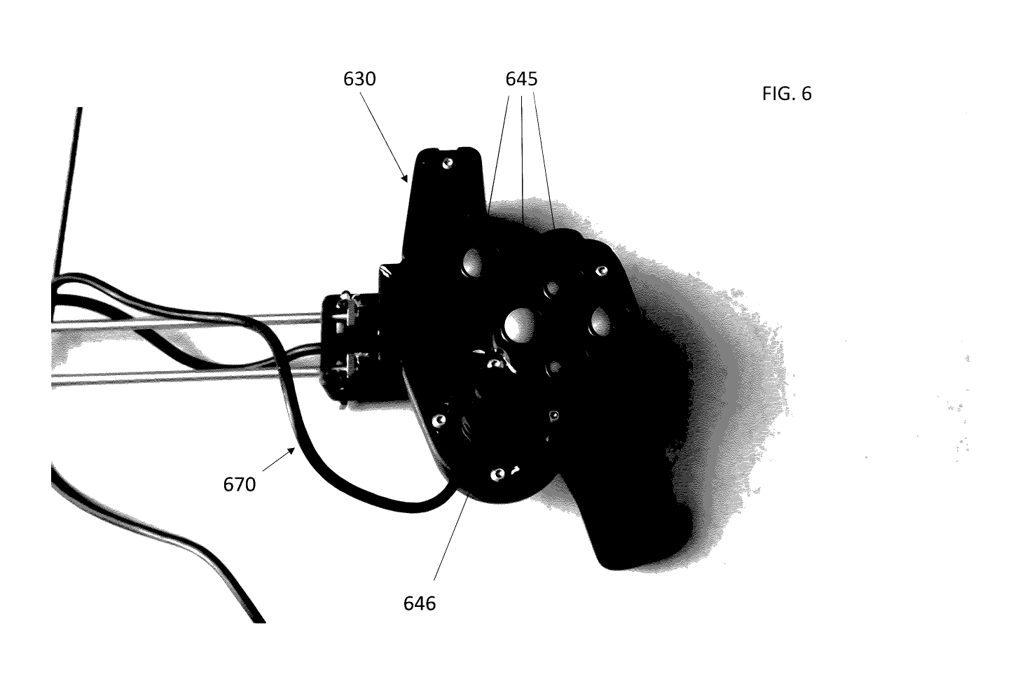

Attention is turned to FIG. 6. A right game controller element 630 includes a plurality of buttons 645 as well as a joystick 646. The arrangement of buttons 645 and joystick 645 is modelled on traditional game controllers but may be modified in any way to fit specific applications and uses. Communication between a tablet and a game controller element 630 may be wired or wireless. Wireless communication is preferred as it obviates the need for a dedicated wire 670, though a power wire may be required even in absence of communication. Wi-Fi and Bluetooth are particularly preferred forms of wireless communication between a mobile electronic device and game controller elements of the instant embodiment. Unlike all prior art inventions, the instant invention may accept a tablet, smartphone, or the like in either a portrait or landscape arrangement relative to the game controller elements 630. This capability adds another dimension to gaming and general capabilities of the instant invention. Tablets, smartphones, and the like from any manufacturer may be adapted to be used in the instant embodiment.

### Third Embodiment

The invention also provides for a device for providing a hardware controller over software for a mobile electronic device, including: a mobile electronic device; a first controller element adapted to be placed on either a right side or a left side of the mobile electronic device; a contact element adapted to bring the first controller element into physical contact with the mobile electronic device; a locking element adapted to keep the first controller element contacted to the mobile electronic device; and, a communication means adapted to allow for communication between the mobile electronic device and the first controller element.

In one aspect of the device, the mobile electronic device is realized as a plurality of mobile electronic devices. In another aspect of the device, the first controller element includes a plurality of programmable buttons as well as a joystick. In still another aspect of the device, the locking element is reversibly openable. In yet another aspect of the device, the mobile electronic device includes at least one app adapted to make use of the plurality of programmable buttons and the joystick associated with the first controller element.

While previous embodiments have discussed game controllers, the instant embodiment includes two unique features: a general hardware controller of software associated with a mobile computing or electronic device as well as a single controller and not a pair as previously described. In the instant embodiment, a single controller with one or a plurality of buttons or input features may be brought into contact or non-contact proximity to laptop screen, tablet computer, smartphone, smart watch or the like and utilized to input signals into the associated electronic device.

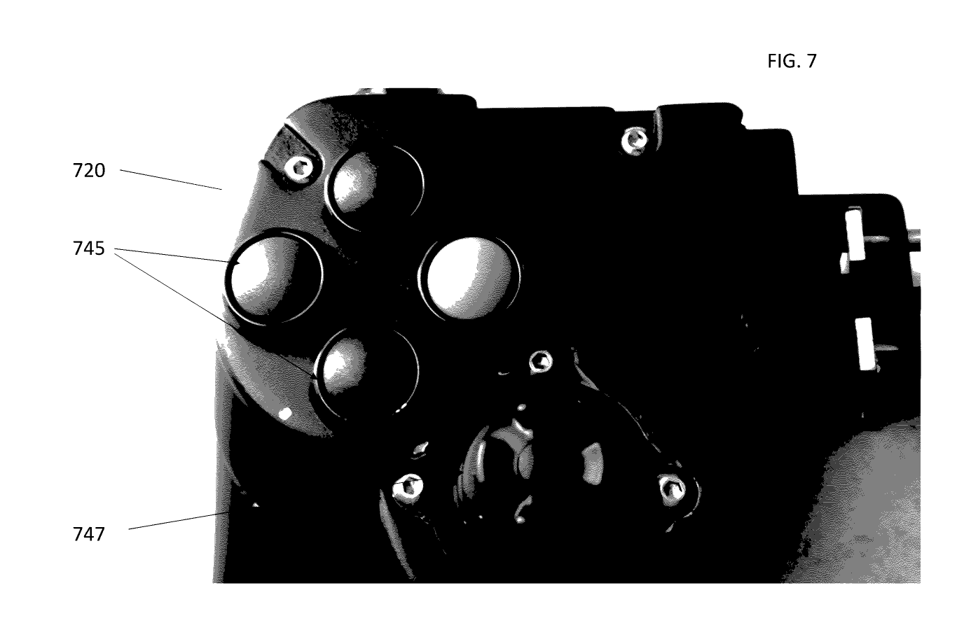

FIG. 7 shows a single controller unit 720 with a plurality of buttons 745 and a joystick 747. The single controller unit is adapted to be placed next to a tablet, smartphone or other mobile electronic or mobile computing device (not shown) and allow for finger-driven functionality either alone or in combination with a touch screen associated with the device with which the controller is associated.

### Fourth Embodiment

The invention also includes a device for providing game controller-functionality to a mobile electronic device, including: a mobile electronic device; a first game controller element adapted to be placed on a first side of the mobile electronic device when a screen associated with the mobile electronic device is facing upwards; a second game controller element adapted to be placed on a second side of the mobile electronic device; a first clamping element adapted to clamp the first game controller in place on the first side of the mobile electronic device; a second clamping element adapted to clamp the second game controller element in place on the second side of the mobile electronic device; and, a communication element adapted to allow for communication between the mobile electronic device and the first game controller element and the second game controller element.

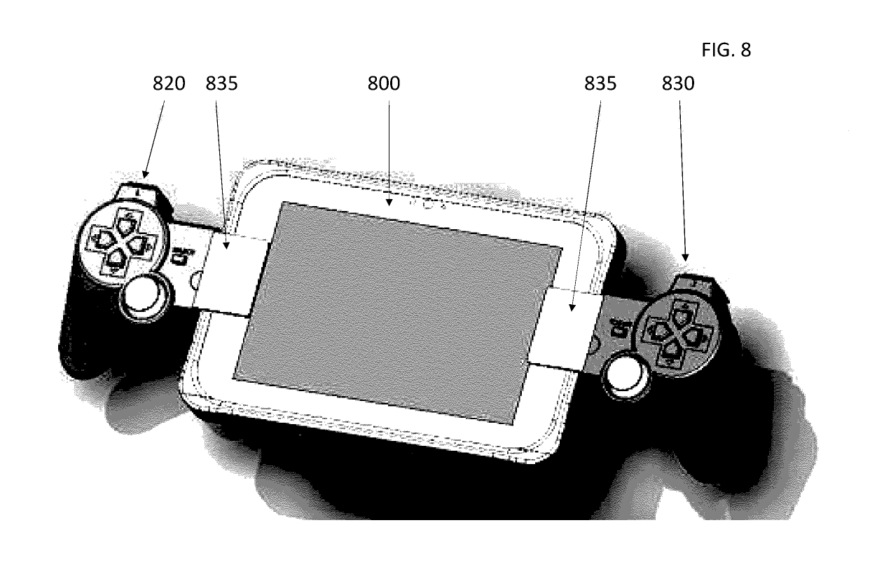

In this embodiment, the sliding element and locking elements have been replaced by clamping elements associated with one or a plurality of (game) controller elements. The controller elements may be clipped or otherwise attached to a tablet computer, smartphone or the lie. The controllers may be linked via a power cord or may be completely independent of one another. The clamping elements may be clamps, clips, holders, links, or other elements that hold the game controller elements in place on the sides of a mobile electronic device. FIG. 8 shows a schematic view of a tablet 800 with game controller elements 820 & 830 with clamps 835 holding the game controllers 820 & 830 in place.

### EXAMPLE

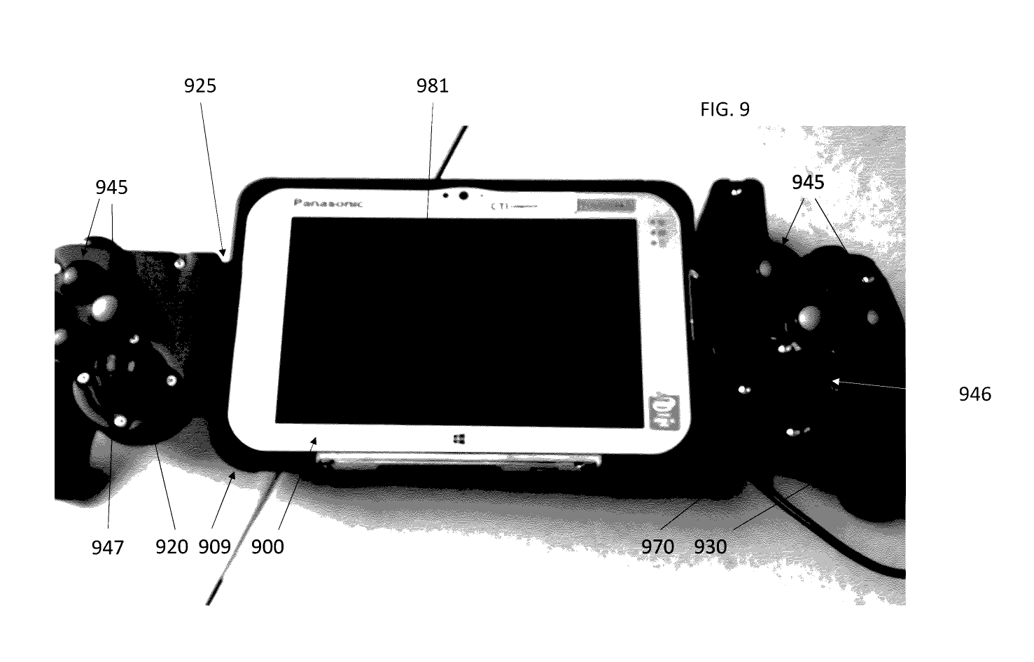

Attention is turned to FIG. 9 which shows a Panasonic tablet 900 with a silicone edge guard 909. Left 920 and right 930 game controller elements are snuggly placed on either side of the tablet 800 with a lip 925 placed to hold the tablet in place. The left game controller element 920 includes a plurality of buttons 945 and a toggle switch 947, while the right game controller element 930 includes a plurality of buttons 945 and a joystick 946. A power wire 970 with a USB end (not shown) attaches to the tablet 900 and provides both electrical energy as well as communication between the tablet 900 and the game controller elements 920 & 930. Touchscreen 981 is fully accessible and may be used in conjunction with the game controller elements 920 &930, or the latter may work without need for touchscreen inputs. The tablet 900 is locked in place as previously described.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. In addition, as used herein the term “about” refers to +/−10%. In addition, when the word “about” is used herein in reference to a number, it should be understood that still another embodiment of the invention includes that number not modified by the presence of the word “about.”

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A device for providing game controller functionality to a mobile electronic device, including:
a mobile electronic device;
a first game controller element adapted to be placed on a right side of said mobile electronic device when a screen associated with said mobile electronic device is facing upwards;
a second game controller element adapted to be placed on a left side of said mobile electronic device;
a sliding element adapted to bring said first game controller and said second game controller into contact with said mobile electronic device;
a locking element adapted to keep said first game controller and said second game controller locked in place and contacted to said mobile electronic device; and,
a communication and power element adapted to allow for communication between said mobile electronic device and said first game controller element and said second game controller element.

2. The device according to claim 1, wherein said mobile electronic device is selected from tablet computer, smartphone, laptop computer, computer screen, personal gaming device, iPod Touch, or handheld computing device.

3. The device according to claim 2, wherein said mobile electronic device is placed in a landscape or portrait orientation relative to said first game controller element and said second game controller element.

4. The device according to claim 1, wherein said communication and power element includes wireless or wired means.

5. The device according to claim 4, wherein said wireless means include Wi-Fi, Bluetooth, IR, or high frequency waves.

6. The device according to claim 1, wherein said sliding element includes metal rods, springs, elastic elements, or plastically deformable features adapted to allow said first game controller element to move relative to said second game controller element.

7. The device according to claim 1, wherein said device allows for touchscreen access to said mobile electronic device in addition to use of said first game controller element and said second game controller element.

8. The device according to claim 2, wherein said mobile electronic device is selected from Apple, Samsung, Microsoft, HP, Dell, HTC, Sony, Google, or Blue.

9. The device according to claim 1, wherein said first game controller element includes a plurality of programmable buttons and wherein said second game controller element includes a plurality of programmable buttons.

10. The device according to claim 9, wherein said first game controller element additionally includes a joystick and wherein said second game controller element includes a toggle stick.

11. A method for providing game controller functionality to a mobile electronic device, including the following:
providing a mobile electronic device;
placing said mobile electronic device on a sliding element, wherein a screen of said mobile electronic device is facing upwards;
pushing a first game controller element from a first side and a second game controller element from a second side of said mobile electronic device along said sliding element until said first game controller element and said second game controller element are in physical contact with said mobile electronic device;
locking said first game controller element and said second game controller element in place along said sliding element; and,
providing electrical communication between said mobile electronic device and said first game controller element and said second game controller element.

12. The method according to claim 11, wherein said mobile electronic device is realized as an iPad or Samsung tablet computer or an iPhone or Samsung Galaxy smartphone.

13. The method according to claim 11, wherein said sliding element is adapted to allow said first game controller element to move relative to said second game controller element.

14. The method according to claim 13, wherein said first game controller element and said second game controller element are adapted to move relative to each other to allow for any type of mobile electronic device to sit between them.

15. The method according to claim 11, wherein said first game controller element is adapted to include a plurality of programmable buttons for right hand use and said second game controller element is adapted to include a plurality of programmable buttons for left hand use.

16. A device for providing a hardware controller over software for a mobile electronic device, including:
a mobile electronic device;
a first controller element adapted to be placed on either a right side or a left side of said mobile electronic device;
a contact element adapted to bring said first controller element into physical contact with said mobile electronic device;
a locking element adapted to keep said first controller element contacted to said mobile electronic device; and,
a communication means adapted to allow for communication between said mobile electronic device and said first controller element.

17. The device according to claim 16, wherein said mobile electronic device is realized as a plurality of mobile electronic devices.

18. The device according to claim 16, wherein said first controller element includes a plurality of programmable buttons as well as a joystick.

19. The device according to claim 16, wherein said locking element is reversibly openable.

20. The device according to claim 18, wherein said mobile electronic device includes at least one app adapted to make use of said plurality of programmable buttons and said joystick associated with said first controller element.

21. A device for providing game controller-functionality to a mobile electronic device, including:
a mobile electronic device;
a first game controller element adapted to be placed on a first side of said mobile electronic device when a screen associated with said mobile electronic device is facing upwards;
a second game controller element adapted to be placed on a second side of said mobile electronic device;
a first clamping element adapted to clamp said first game controller in place on said first side of said mobile electronic device;
a second clamping element adapted to clamp said second game controller element in place on said second side of said mobile electronic device; and,
a communication element adapted to allow for communication between said mobile electronic device and said first game controller element and said second game controller element.
